(19) United States
(12) Patent Application Publication
(10) Pub. No.: US 2015/0036194 A1
(43) Pub. Date: Feb. 5, 2015

(54) IMAGE PROCESSING APPARATUS AND IMAGE PROCESSING SYSTEM

(71) Applicant: Oki Data Corporation, Tokyo (JP)

(72) Inventor: Mutsumi ARAI, Tokyo (JP)

(73) Assignee: OKI DATA CORPORATION, Tokyo (JP)

(21) Appl. No.: 14/331,778

(22) Filed: Jul. 15, 2014

(30) Foreign Application Priority Data
Jul. 31, 2013 (JP) 2013-158535

(51) Int. Cl. H04N 1/32; H04N 1/21

(52) U.S. Cl. CPC H04N 1/32122; H04N 1/2166; H04N 2201/3226; H04N 2201/0094; H04N 2201/21
USPC 358/403

(57) ABSTRACT

An image processing apparatus according to the invention includes: an input unit for receiving entries of start, continuation, and end of reading operation of an image on a medium; a reading unit for reading the image on the medium according to an instruction of the start or the continuation to produce reading data; a file production unit for producing a reading data file produced as a file from the reading data at each reading operation sectioned according to the instruction of the continuation; a file name providing unit for providing a file name at each reading data file; and a file list production unit for producing a file list based on the file name, wherein the reading data file and the file list are sent to a predetermined memory device according to the instruction of the end.

### CROSS REFERENCE TO RELATED APPLICATION

This application claims priority benefits under 35 USC, section 119 on the basis of Japanese Patent Application No. 2013-158535, the disclosure of which is incorporated herein by reference.

### BACKGROUND OF THE INVENTION

1. Field of the Invention

This invention relates to an image processing apparatus transmitting read out image data and to an image processing system having such an image processing apparatus.

2. Background of Related Art

Prior art image processing apparatuses and systems may have a function sending image data scanned with a scanner to external devices such as, e.g., personal computers (see, e.g., Japanese Patent Application Publication No. 2009-253588 (A1)).

With such prior art apparatuses, however, there arises a problem that a user may hardly distinct image data read out by himself because the image data of an original document sent to the external device after read out with the scanner are not summarized on a job basis of the reading operation through sequential reading operations.

It is an object of the invention, in consideration for solving the above problem, to provide an image processing apparatus allowing a user to readily distinct read out image data.

### SUMMARY OF THE INVENTION

To solve the above problems, an image processing apparatus according to the invention comprises: an input unit for receiving entries of start, continuation, and end of reading operation of an image on a medium; a reading unit for reading the image on the medium according an instruction of the start or the continuation to produce reading data; a file production unit for producing a reading data file produced as a file from the reading data at each reading operation sectioned according to the instruction of the continuation; a file name providing unit for providing a file name at each reading data file; and a file list production unit for producing a file list based on the file name, wherein the reading data file and the file list are sent to a predetermined memory device according to the instruction of the end.

According to the image processing apparatus of the invention, the image processing apparatus advantageously allows the user to readily distinct read out image data.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram showing a structure of an image processing system according to a first embodiment of the invention;

FIG. 2 is a block diagram showing a structure of an essential portion of an MFP according to the first embodiment;

FIG. 3A, 3B are diagrams illustrating user's instructions and operations according to the first embodiment;

FIG. 4 is a flowchart showing a flow of processings done in the MFP according to the first embodiment;

FIG. 5 is a flowchart showing a flow for making a reading data file according to the first embodiment;

FIG. 6 is a flowchart showing a flow for a file list production processing according to the first embodiment;

FIG. 7 is a block diagram showing a structure of an image processing system according to a second embodiment of the invention;

FIG. 8 is a block diagram showing a structure of an essential portion of an MFP according to the second embodiment; and

FIG. 9 is a flowchart showing a flow of processings done in the MFP according to the second embodiment.

### DETAILED DESCRIPTION OF EMBODIMENTS

Hereinafter, referring to the drawings, an embodiment of the invention is described. It is to be noted that the invention is not limited to those described below and that the invention is modifiable as far as not deviated from the scope of the invention.

### First Embodiment

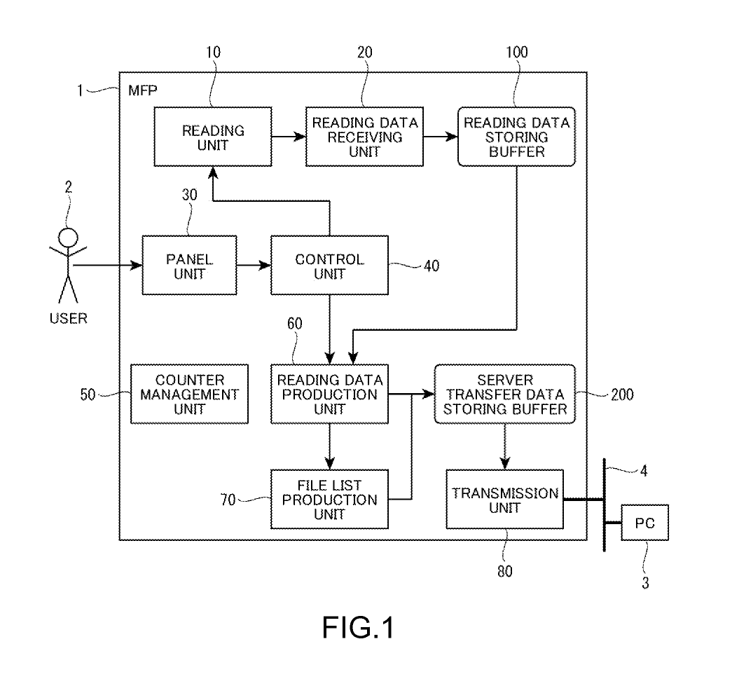

FIG. 1 shows a block diagram showing a structure of an image processing system according to a first embodiment of the invention. In FIG. 1, an image processing system is structured of a MFP (multifunction peripheral) 1 serving as an image processing apparatus, a PC (personal computer) 3 serving as a predetermined memory device, and a network 4 as a communication line connecting the MFP 1 and the PC 3 with each other in a way communicating with each other. The MFP 1 receives entry manipulations done by a user 2, and transfers image data of an original document read out at a reading unit 10 to the PC 3 via the network 4. In this embodiment, this operation is called as “ScanToNetwork PC.” In this embodiment, the reading unit 10 reads out images on original documents, as one type of media, which have a broad meaning and can be any type of paper or sheet materials. The term “predestined memory device” includes internal and external memory devices, or any other memory devices including removable memory devices. The PC 3 herein serves as an external memory device as one type of the predetermined memory devices.

The MFP 1 is constituted of the reading unit 10, a reading data receiving unit 20, a panel unit 30, a control unit 40, a counter management unit 50, a reading data production unit 60, a file list production unit 70, a transmission unit 80, a reading data storing buffer 100, and a server transfer data storing buffer 200. The reading unit 10 produces image data (hereinafter, referred to as “reading data”) by reading the images on the original documents, and stores the reading data in the reading data storing buffer 100 serving as a reading data storing region via the reading data receiving unit 20.

The panel unit 30 serving as an input unit receives entry manipulations instructing start, continuation, or end of reading operation of the original document images done by the user 2, and notifies the control unit 40 of the entered instruction. The panel unit 30 includes a displaying unit such as, e.g., a display device and can display information of various types. Where the panel unit 30 receives entry manipulations instructing start or continuation of reading operation of the original document images and notifies the control unit 40 of the instruction of the start or the continuation, the control unit 40 notifies the reading unit 10 of the start of reading operation. Where the panel unit 30 receives entry manipulations instructing the end of reading operation of the original document images and notifies the control unit 40 of the instruction of the end, the control unit 40 notifies the reading data production unit 60 of the start of file production and file transmission processing.

The reading data production unit 60 makes a file or files at each reading operation sectioned according to the instruction of the continuation received at the panel unit 30 upon reading out the reading data from the reading data storing buffer 100, and produces, from the file thus made, a reading data file given with a name to be stored in the server transfer data storing buffer 200. The reading data production unit 60 notifies the file list production unit 70 of the name provided at the file as a file name.

When notified of the file names from the reading data production unit 60, the file list production unit 70 produces a file list recording the file names of the reading data files read from the instruction of the start to the instruction of the end received at the panel unit 30 based on the file names thus notified. Where all of the reading data in the reading data storing buffer 100 are processed, the file list production unit 70 stores the produced file list in the server transfer data storing buffer 200. The transmission unit 80 transmits the reading data file and the file list stored in the server transfer storing buffer 200 to the external memory device such as, e.g., the PC 3, when the panel unit 30 receives the entry manipulation instructing the end of reading operation of the original document images, and when the control unit 40 notifies the start of the file transmission processing.

The counter management unit 50 manages a number of the reading data files and a blank page number as described below, and has a function to return values of the number of the reading data files and the blank page number on demand from the exterior. With the MFP 1 thus structured, operations of the entire apparatus are controlled by the control unit 40 structured of such as a CPU (Central Processing Unit) based on control program (software) memorized in a memory means such as memories or the like.

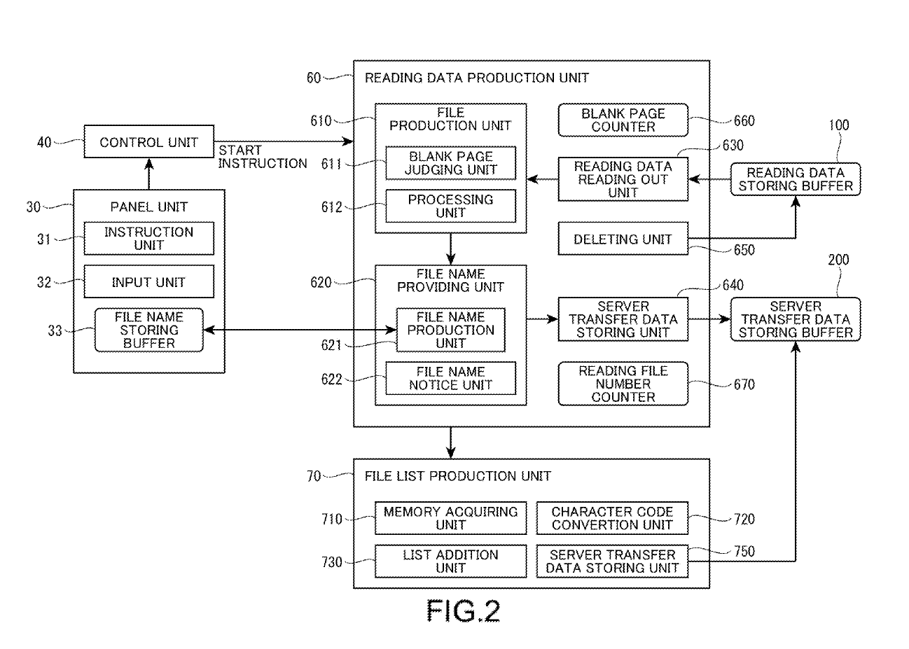

FIG. 2 is a block diagram showing a structure of an essential portion of an MFP according to the first embodiment. In FIG. 2, the panel unit 30 is structured of an instruction unit 31, an input unit 32, and a file name storing buffer 33. The input unit 32 detects entry manipulations such as key entries done by the user, and the instruction unit 31 notifies the control unit 40 of the instruction of the start, continuation, or end based on the entry manipulations detected with the input unit 32. The file name designated by the user is stored in the file name storing buffer 33. The reading data production unit 60 is structured of a file production unit 610, a file name providing unit 620, a reading data reading out unit 630, a server transfer data storing unit 640, a deleting unit 650, a blank page counter 660, and a reading file number counter 670.

The file production unit 610 is structured of a blank page judging unit 611, a processing unit 612. The blank page judging unit 611 judges as to whether the reading data is of a blank page. The processing unit 612 processes the reading data into files of certain formats such as, e.g., tiff (Tagged Image File Format), jpeg (Joint Photographic Experts Group), designated by the user, and makes reading data files from the reading data at each reading operation sectioned according to the instruction of the continuation received at the panel unit 30. The file format such as tiff, and jpeg, is designated by the user at the panel unit 30. Where the blank page judging unit 611 judges that the reading data are the data of the blank page, those reading data are excluded from the reading data file.

The file name providing unit 620 is structured of a file name production unit 621, and a file name notice unit 622. The file name production unit 621 reads out the file name designated by the user from the file name storing buffer 33 of the panel unit 30, and provides a file name at each reading data file produced at the file production unit 610. The file name notice unit 622 notifies the file list production unit 70 of the file name provided by the file name production unit 621. The reading data reading out unit 630 reads out the reading data from the reading data storing buffer 100 and notifies the file production unit 610. The server transfer data storing unit 640 receives, from the file name providing unit 620, the reading data file produced upon providing the file name with the file name providing unit 620, and store and saves the data in the server transfer data storing buffer 200.

The deleting unit 650 deletes the reading data stored in the reading data storing buffer 100. The blank page counter 660 is a counter for counting up a number of blank pages detected from the reading data by the blank page judging unit 611 of the file production unit 610. The reading file number counter 670 is a counter for counting up a number of the reading data files produced by the file production unit 610.

The file list production unit 70 is structured of a memory acquiring unit 710, a character code conversion unit 720, a list addition unit 730, and a server transfer data storing unit 750. The memory acquiring unit 710 retrieves a memory region for producing a file list. The character code conversion unit 720 converts the file name notified from the file name notice unit 622 to a character code. The list addition unit 730 adds the character code of the file name converted at the character code conversion unit 720 to the file list. The server transfer data storing unit 750 saves the produced file lists in the server transfer data storing buffer 200.

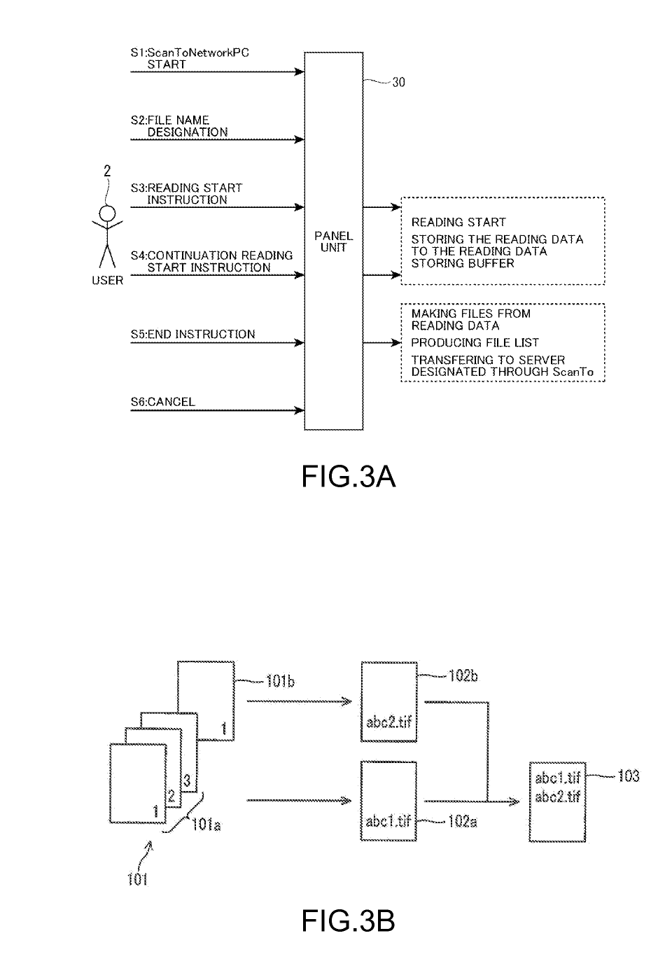

Next, user's instructions and operation of the MFP are described along steps indicated with “S” in FIG. 3A as a diagram for user's instructions and operation according to the first embodiment in reference with FIG. 1 and FIG. 3B. It is to be noted that FIG. 3B is a diagram illustrating reading data, reading data files, and a file list.

The user 2 enters an instruction to the start operation of ScanToNetworkPC at Step 51, and when the panel unit 30 of the MFP 1 receives the entry, the MFP 1 starts operation of ScanToNetworkPC.

The user 2 designates a file name as a name given to a reading data file, and receives an entry of the file name of the panel unit 30 at Step S2. At Step S3, the user 2 inputs the instruction of reading start upon setting an original document to the reading unit 10. When the panel unit 30 receives the instruction, the reading unit 10 of the MFP 1 starts the reading operation of the original documents thus set, and stores the reading data in the reading data storing buffer 100 via the reading data receiving unit 20.

The user 2 subsequently sets the original documents continuously to the reading unit 10 where original documents to be read are remaining at Step S4, and enters the instruction of the continuation of reading. When the panel unit 30 receives the instruction, the reading unit 10 of the MFP 1 does the reading operation of the original documents in the same manner as the reading operation according to the first instruction of the reading start, and stores the reading data in the reading data storing buffer 100 via the reading data receiving unit 20. The MFP 1 repeats this reading operation until no more original document to be read.

When reading all of the original documents is completed, the user 2 enters an instruction of the end of the reading operation structure at Step S5, and when the panel unit 30 receives the instruction, the reading data production unit 60 of the MFP 1 converts the reading data 101 (101a, 101b) of the original documents into files at each reading operation sectioned according to the instruction of the continuation received at the panel unit 30 as shown in FIG. 3B, and produces reading data files 102 (102a, 102b) upon giving names, respectively. The file list production unit 70 produces a file list 103 recording the names of each reading data file 102 such as, e.g., “abc1.tif,” “abc2.tif.”

The reading data 101a and the reading data 101b, as shown in FIG. 3B are the reading data of each reading operation sectioned according to the instruction of the continuation received at the panel unit 30, and the reading data file 102a and the reading data file 102b are produced from the reading data 101a and the reading data 101b. The transmission unit 80 of the MPF 1 transmits the produced reading data files and the produced file list to the external memory device such as, e.g., the PC 3 designated through the command “ScanToNetwrkPC” to transfer the files and the list. When completing the transfer, the MPF 1 finishes the operation of “ScanToNetwrokPC.”

To the contrary, if the reading operation of the original document is stopped, the user 2 enters an instruction of cancelation. When the panel unit 30 receives the instruction, the reading unit 10 of the MFP 1 stop the reading operation of the original documents, and the reading data production unit 60 deletes the reading data saved in the device. Upon completion of the deletion, the MFP 1 finishes the operation of “ScanToNetwrkPC.”

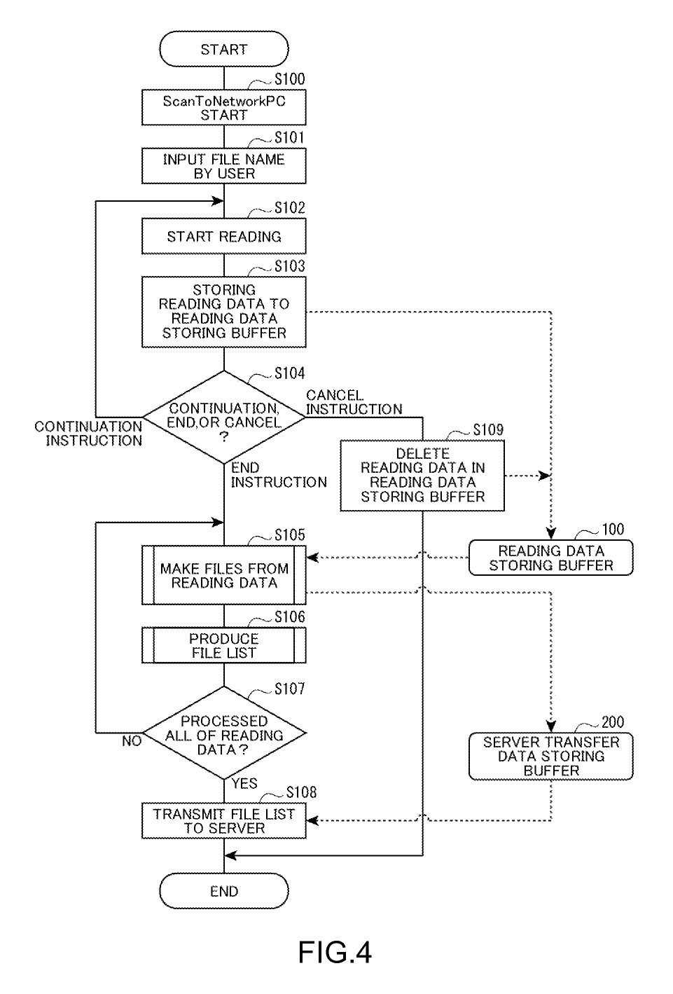

Advantages of the image processing apparatus according to this embodiment are described herein. The processing done by the MFP 1 is described in referring to FIGS. 1, 2 along the steps indicated with a letter “S” in the flowchart showing a flow in FIG. 4 for the processing in the MFP according to the first embodiment.

At Step 100, the user 2 enters an instruction to the start operation of ScanToNetworkPC, and when the panel unit 30 of the MFP 1 receives the entry, the control unit 40 of the MFP 1 starts operation of ScanToNetworkPC.

The user 2 may make an entry for designating a file name as a name given to the reading data file at Step S101, and the panel unit 30 receives an entry of the file name. The user 2 at Step S102 sets the original documents to the reading unit 10 and enters an instruction of the reading start. When the panel unit 30 receives the instruction, the reading unit 10 of the MFP 1 starts the reading operation of the original documents. At Step S103, the reading unit 10 reads all of the original documents until no more original document thus set, and stores the al of the reading data of the original documents thus read in the reading data storing buffer 100 via the reading data receiving unit 20.

If the original documents to be read out are remaining at Step S104, the user 2 sets the original documents to be read at the reading section and enters an instruction of the continuation for continuing the reading operation. When the panel unit 30 receives the instruction, the control unit 40 shifts the processing to step S102 and starts the reading operation of the original documents. If no original document to be read is remaining, or namely if reading all of the original documents is completed, the user 2 may make an entry of instruction of the end for completing the reading operation, and the control unit 40 shifts the processing to Step S105 when the panel unit 30 receives the entry of the instruction of the end. If this processing is to be stopped, the user 2 enters an instruction of cancellation to stop the reading operation, and when the panel unit 30 receives the entry of the instruction of cancellation, the control unit 40 shifts the processing to the Step S109.

At Step S105, the reading data production unit 60 makes a file in a format of such as, e.g., tiff or jpeg, from the reading data stored in the reading data storing buffer 100, thereby producing the reading data file. The processing for making a file from the reading data is described below in detail. The file list production unit 70 produces a list of the names of the produced reading data files as a file list at Step S106. The control unit 40 judges as to whether all of the reading data are already processed or namely as to whether production of the reading data file and the list file is completed, and if it is judged as completed, the processing goes to Step S108 whereas if it is not judged as not completed, the processing goes to Step S105.

If it is judged as that production of the reading data file of all of the reading data and the list file is completed, the server transfer data storing unit 750 of the file list production unit 70 stores the produced file list in the server transfer data storing buffer 200, and the transmission unit 80 transmits the file list stored in the server transfer data storing buffer 200 to the external memory device such as the PC 3 designated by the user 2 according to the instruction from the control unit 40 to complete this processing.

To the contrary, if the panel unit 30 receives the entry manipulation of the instruction of cancellation at Step S 104, the deleting unit 650 of the reading data production unit 60 deletes all of the reading data stored in the reading data storing buffer 100, and this processing is made completed.

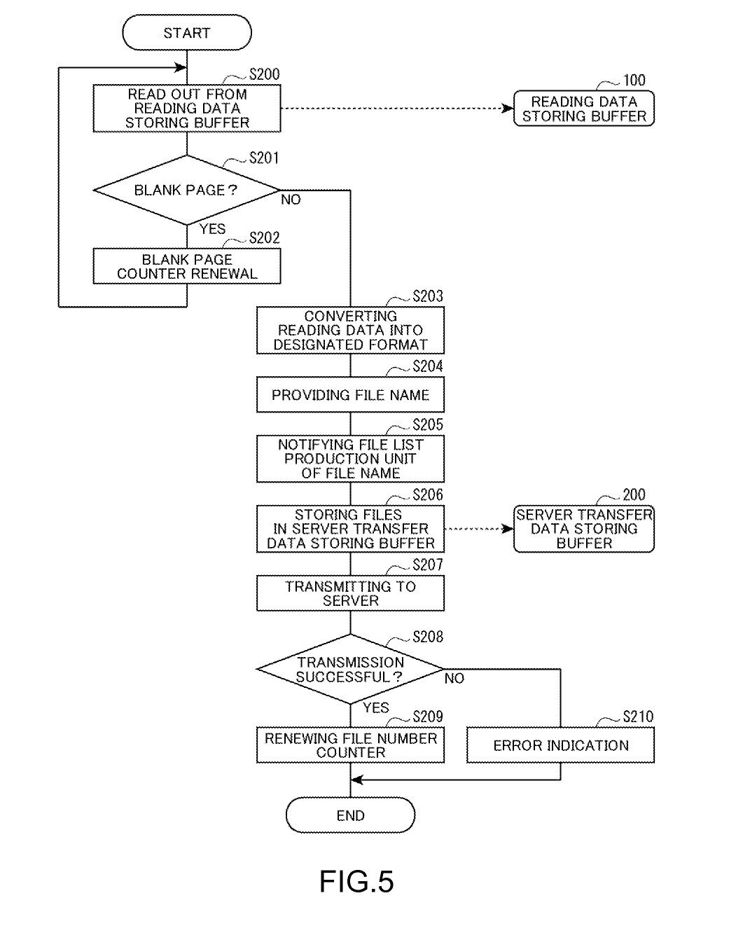

Next, a processing for making a file from reading data with the reading data production unit 60 is described along steps indicated with “S” in FIG. 5 as a flowchart showing a flow of the processing for making a file from the reading data according to the first embodiment in reference with FIG. 1 and FIG. 2. The processing is a processing done at Step S105 in FIG. 4. The reading data reading out unit 630 of the reading data production unit 60 reads out a portion of one file of the reading data from the reading data storing buffer 100 and transfers the reading data to the file production unit 610 at step 200.

The blank page judging unit 611 of the file production unit 610 judges as to whether the given reading data indicate the blank page at Step S201. If it is judged as a blank page, the processing goes to Step S202, whereas if it is judged as not a blank page, the processing goes to Step S203. If the blank page judging unit 611 judges as the blank page, the file production unit 610 renews the blank page counter 660 or namely adds one to the counter, and the processing goes to Step S200 to perform the subsequent reading data processing. In a case of the blank page, the reading data file is not produced.

To the contrary, if the blank page judging unit 611 judges that it is not a blank page at Step S201, the processing unit 612 of the file production unit 610 converts the reading data into data in a designated format such as, e.g., tiff or jpeg, and produces a reading data file at Step S203. When the reading data file is produced, the file name production unit 621 of the file name providing unit 620 retrieves the file name from the file name storing buffer 33 of the panel unit 30, and provides the retrieved file name as a file name of the reading data file at Step S204.

The file name notice unit 622 of the file name providing unit 620 notifies the file list production unit 70 of the file name of the reading data file produced with the file name production unit 621 at Step S205. The server transfer data storing unit 640 stores the reading data file produced at the file production unit 610 in the server transfer data storing buffer 200 at Step S206. The transmission unit 80 transmits the reading data file stored in the server transfer data storing buffer 200 to the external memory device such as the PC 3 according to the instruction from the control unit 40 at Step S207.

The control unit 40 judges at Step S208 as to whether the transmission of the reading data file done by the transmission unit 80 is successful, and if the transmission is successful, the processing goes to Step S209, whereas the transmission is not successful, the processing shifts to Step S210. If the transmission is successful, the reading data production unit 60 renews the reading file number counter 670 or namely adds one to the counter at Step S209, thereby the apparatus ending the processing. To the contrary, if the transmission is unsuccessful, the panel unit 30 at Step S210 displays an error indication as the transmission was failed, thereby the apparatus ending the processing.

The counter management unit 50 returns, on demand from the exterior, the reading data file number as a value of the reading file number counter 670 and the value of the blank page number as a value of the blank page counter 660. Because the reading data file number as a value of the reading file number counter 670 and the value of the blank page number as a value of the blank page counter 660 are returned on demand from the exterior, the exterior device can inform the user of the reading file number and the blank page number upon displaying those numbers.

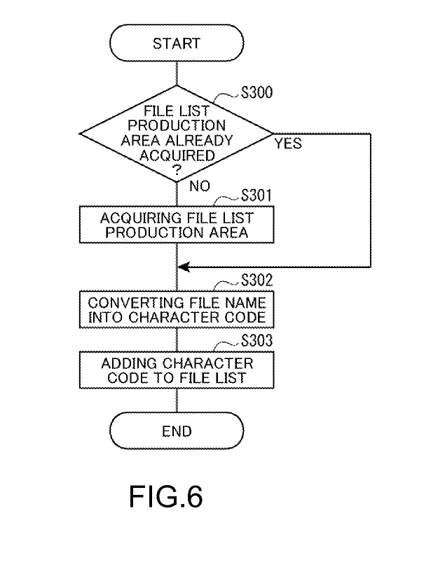

Next, a processing for producing a file list done with the file list production unit 70 is described along steps indicated with “S” in FIG. 6 as a flowchart showing a flow of the processing for producing a file list according to the first embodiment in reference with FIG. 1 and FIG. 2. It is to be noted that this processing is performed at step S106 in FIG. 4. At Step S300, the memory acquiring unit 710 of the file list production unit 70 judges as to whether a file list production area is already acquired at Step S300. If it is judged as already acquired, the processing goes to Step S302, and if it is judged as not yet acquired, the processing goes to Step S301.

If judging as that the memory area is not yet acquired, the memory acquiring unit 710 acquires a memory area for producing a file list at Step S301. The character code conversion unit 720 converts the file name notified from the file name notice unit 622 of the file name providing unit 620 into a character code or codes at Step S302. The list addition unit 730 adds the converted character code or codes to the file list, thereby ending this processing.

Thus, according to this embodiment, the apparatus makes a file or file on a basis of reading operation from the reading data of the original documents read out through a series of the reading operations between the instruction of the start and the instruction of the end for the reading operation on the original documents entered by the user's manipulations, provides the file names, and produces the file names as the file list, so that the user can easily identify the reading data by looking up the file list. As described above, according to the first embodiment, the reading data of the original documents read out through the series of the reading operations are made into the files on the basis of the reading operation; the file names are given; and the file list is produced from the file names. It is therefore advantageous for the users to easily identify the read out image data.

### Second Embodiment

The MFP according to the second embodiment has a structure of the MFP according to the first embodiment except the reading data receiving unit, which is replaced to a reading data reception storing control unit. The structure according to the second embodiment is described based on a block diagram showing a structure of an image processing system according to the second embodiment and a block diagram showing an essential portion of the MFP according to the second embodiment. It is to be noted that substantially the same portions as those in the first embodiment are assigned with the same reference numbers and their descriptions are omitted.

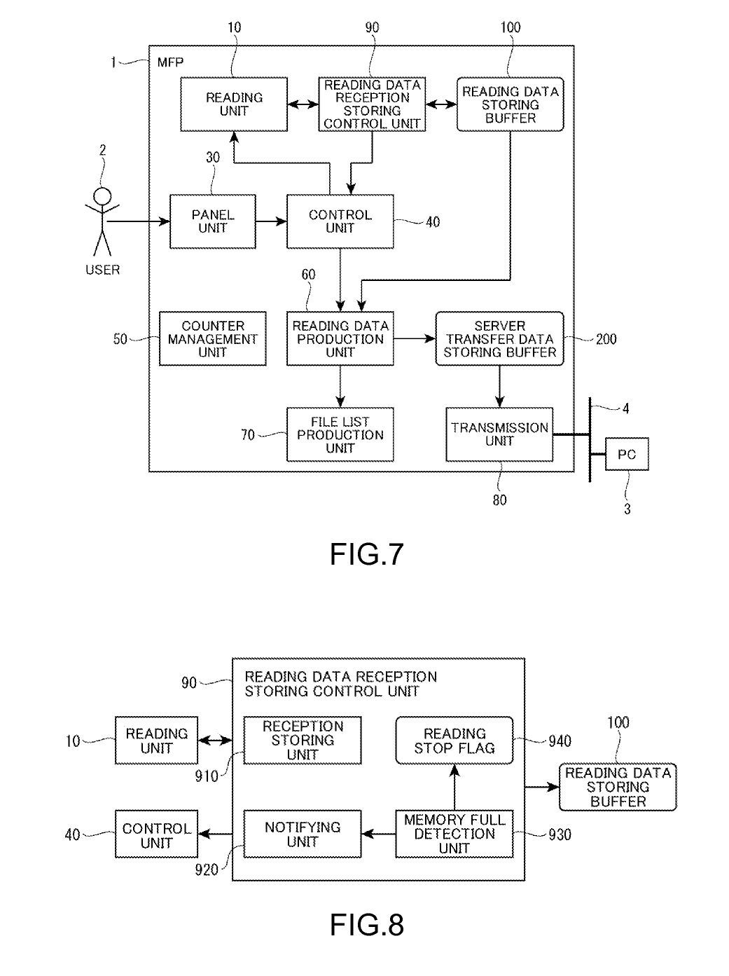

In FIG. 7, the MFP 1 is constituted of the reading unit 10, a reading data reception storing control unit 90, the panel unit 30, the control unit 40, the counter management unit 50, the reading data production unit 60, the file list production unit 70, the transmission unit 80, the reading data storing buffer 100, and the server transfer data storing buffer 200. The reading data reception storing control unit 90 stores the reading data read at the reading unit 10 in the reading data storing buffer 100. The reading data reception storing control unit 90 detects a memory full state when the reading data storing buffer 100 has no area for storing reading data, and stops the subsequent reading operation and does processing of the instruction of the end.

In FIG. 8, the reading data reception storing control unit 90 is structured of a reception storing unit 910, a notifying unit 920, a memory full detection unit 930, and a reading stop flag 940. The reception storing unit 910 receives the reading data from the reading unit 10 and stores the data in the reading data storing buffer 100. When the memory full detection unit 930 detects that the reading data storing buffer 100 serving as a reading data storing area storing reading data has no empty memory area for storing reading data and enters in the memory full state, the memory full detection unit 930 memorizes information that the reading operation is temporarily stopped in the reading stop flag 940 and notifies the notifying unit 920. The notifying unit 920 requests reading operation stop to the reading unit 10 and execution of the instruction of the end to the control unit 40.

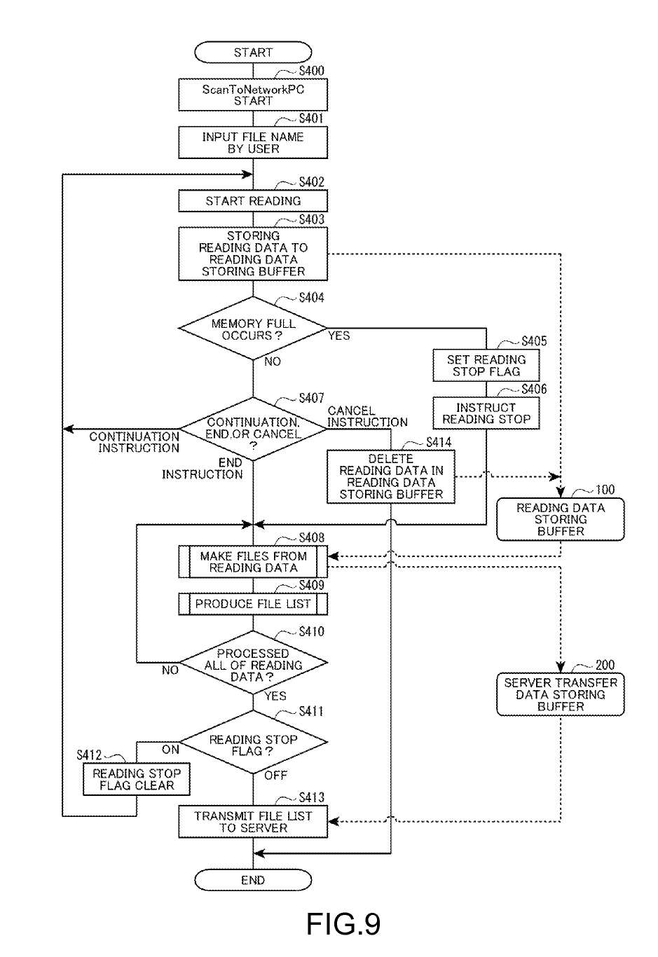

In operation, a processing done with the MFP is described along steps indicated with “S” in FIG. 9 as a flowchart showing a flow of the processing of the MFP according to the second embodiment in reference with FIG. 7 and FIG. 8. The processings at Steps S400 to S403 are substantially the same as the processings at Steps S100 to S103 in FIG. 4, and therefore, a description for those processings is omitted for sake of brevity. At Step S404, the memory full detection unit 930 of the reading data reception storing control unit 90 judges as to whether the reading data storing buffer 100 is in the memory full state, and if it is in the memory full state, the processing goes to Step S405 whereas if it is not in the memory full state, the processing goes to Step S407.

The memory full detection unit 930 judging as that the reading data storing buffer 100 is in the memory full state, memorizes the information rendering the reading operation stop in the reading stop flag 940, and notifies the notifying unit 920 at Step S405. The notifying unit 920 of the reading data reception storing control unit 90 requests reading operation stop to the reading unit 10 and execution of the instruction of the end to the control unit 40 at Step S406, and the processing goes to Step S408, thereby performing substantially the same processing as user's entry of the instruction of the end.

The processings at Steps S407 to S410 are substantially the same as the processings at Steps S104 to S107 in FIG. 4, and therefore, a description for those processings is omitted for sake of brevity. The control unit 40 judges as Step S411 as to whether the reading stop flag 940 memorizes information to stop the reading operation, and if it is memorized or namely, the reading stop flag 940 is turned on, the reading data storing buffer 100 is in the memory full state, and the processing goes to Step S412 because the user's instruction of the end is not entered, thereby resuming reading operation of the original documents. To the contrary, the control unit 40 judging as that the reading stop flag 940 does not memorize any information to stop the reading operation or namely that the reading stop flag 940 is turned off, shifts the processing to Step S413 because it is judged that the reading data storing buffer 100 is not in the memory full state and that the user's instruction of the end is entered.

The reading data reception storing control unit 90 deletes the information memorized in the reading stop flag 940 for stopping the reading operation at Step S412, and the processing shifts to Step S402, thereby resuming the reading operation of the original documents. The processings at Steps S413, S414 are substantially the same processing as those at Steps S108, S109 in FIG. 4, and the description for those processings is omitted for the sake of brevity.

In this embodiment, when the memory full detection unit 930 of the reading data reception storing control unit 90 detects that the reading data storing buffer 100 has no empty area for storing the reading data, this apparatus temporarily stops the reading operation, transmits the reading data file produced at the reading data production unit 6—to the external memory device such as the PC 3. The apparatus resumes the reading operation after ensuring the empty area for storing the reading data in the reading data storing buffer 100, and adds the reading file name continuously to the file list.

With this apparatus, where the reading data storing buffer loses the reading data storing area prior to user's entry manipulation of the instruction of the end and makes unable the reading operation continuously, because the file list can be produced in advance by doing processings of the reading data stored in the reading data storing buffer, the storing area of the reading data in the reading data storing buffer 100 can be ensured, and the file names of the reading data read out through subsequent original document reading processings can be added to the file list previously produced.

As described above, according to the second embodiment, in addition to the advantages of the first embodiment, where the reading data storing buffer loses the reading data storing area prior to user's entry manipulation of the instruction of the end and makes unable the reading operation continuously, because the file list can be produced in advance by doing processings of the reading data stored in the reading data storing buffer, the file list of all of the reading data of the original documents read out through the user's manipulation can be produced, and the file list can be produced advantageously on a job basis as user desires.

In the first and second embodiments, it is described that the MFP produces the file list, but it is not limited to this structure, and an external memory device such as the PC may produce a file list.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

1. An image processing apparatus comprising:
an input unit for receiving entries of start, continuation, and end of reading operation of an image on a medium;
a reading unit for reading the image on the medium according to an instruction of the start or the continuation to produce reading data;
a file production unit for producing a reading data file produced as a file from the reading data at each reading operation sectioned according to the instruction of the continuation;
a file name providing unit for providing a file name at each reading data file; and
a file list production unit for producing a file list based on the file name, wherein the reading data file and the file list are sent to a predetermined memory device according to the instruction of the end.

2. The image processing apparatus according to claim 1, wherein the file list includes the file name of the reading data file read between the instruction of the start and the instruction of the end.

3. The image processing apparatus according to claim 1, wherein the reading data file excludes the reading data when the reading data are data of a blank page.

4. The image processing apparatus according to claim 1, further comprising a reading data file counter for counting up a number of the reading data files produced with the file production unit,
wherein the number of the reading data files is sent back to an external unit on demand of the external unit.

5. The image processing apparatus according to claim 1, wherein the file production unit includes a blank page counter for counting up a number of blank pages detected from the reading data, wherein the number of the blank pages is sent back to an external unit on demand of the external unit.

6. The image processing apparatus according to claim 1, further comprising a memory full detection unit for detecting no more empty region storing the reading data in a reading data storing region as a region for storing the reading data,
wherein, when the memory full detection unit detects no more empty region storing the reading data in the reading data storing region, the reading operation is temporarily stopped to send the reading data file produced at the file production unit to the external memory device, and after an empty region storing the reading data is ensured in the reading data storing region, the reading operation is resumed to continuously add the reading data file name to the file list.

7. An image processing system comprising the image processing apparatus according to claim 1.

8. The image processing system according to claim 7, wherein the predetermined memory device is an external memory device communicable with the image processing apparatus.

9. An image processing apparatus comprising:
an input unit for receiving entries of start, continuation, and end of reading operation of an image on a medium;
a reading unit for reading the image on the medium according to an instruction of the state or the continuation to produce reading data;
a reading data production unit for producing a reading data file and a file name from the reading data at each reading operation;
a file list production unit for producing a file list based on the file name; and
a control unit for sending the reading data file and the file list to a predetermined memory device according to the instruction of the end.

10. The image processing apparatus according to claim 9, wherein the control unit controls data production operation at the reading data production unit according to the entry given at the input unit.

11. The image processing apparatus according to claim 9, wherein the reading data production unit includes a file production unit for producing the reading data file produced at each reading operation sectioned according to the instruction of the continuation, and a file name providing unit for providing the file name at each reading data file.

12. The image processing apparatus according to claim 11, further comprising a reading data file counter for counting up a number of the reading data files produced with the file production unit,
wherein the number of the reading data files is sent back to an external unit on demand of the external unit.

13. The image processing apparatus according to claim 11, wherein the file production unit includes a blank page counter for counting up a number of blank pages detected from the reading data,
wherein the number of the blank pages is sent back to an external unit on demand of the external unit.

14. The image processing apparatus according to claim 9, wherein the file list includes the file name of the reading data file read between the instruction of the start and the instruction of the end.

15. The image processing apparatus according to claim 9, wherein the reading data file excludes the reading data when the reading data are data, of a blank page.

16. The image processing apparatus according to claim 11, further comprising a memory full detection unit for detecting no more empty region storing the reading data in a reading data storing region as a region for storing the reading data,
wherein, when the memory full detection unit detects no more empty region storing the reading data in the reading data storing region, the reading operation is temporarily stopped to send the reading data file produced at the file production unit to the external memory device, and after an empty region storing the reading data is ensured in the reading data storing region, the reading operation is resumed to continuously add the reading data file name to the file list.

17. The image processing apparatus according to claim 9, wherein the predetermined memory device is an external memory device, which is communicable with the image processing apparatus.
